(19) United States
(12) Patent Application Publication
(10) Pub. No.: US 2015/0367890 A1
(43) Pub. Date: Dec. 24, 2015

(54) VEHICLE BODY STRUCTURE

(71) Applicant: TOYOTA JIDOSHA KABUSHIKI KAISHA, Toyota-shi (JP)

(72) Inventor: Hiroyuki KUROKAWA, Nisshin-shi (JP)

(73) Assignee: TOYOTA JIDOSHA KABUSHIKI KAISHA, Toyota-shi (JP)

(21) Appl. No.: 14/732,090

(22) Filed: Jun. 5, 2015

(30) Foreign Application Priority Data
Jun. 24, 2014 (JP) 2014-129396

(51) Int. Cl. B62D 21/15; B62D 27/06

(52) U.S. Cl. CPC B62D 21/152; B62D 27/065

(57) ABSTRACT

A vehicle body structure including a pair of left and right upper members that are disposed along a vehicle body longitudinal direction, a pair of left and right pillars that extend in a vehicle body vertical direction and that are disposed at vehicle width direction insides of the pair of left and right upper members, reinforcement that extends in a vehicle width direction, that is disposed between the pair of left and right pillars, and that supports a steering section, and a fastening portion where a vehicle width direction outside end portion of the reinforcement, the pillar, and the upper member are fastened together in the extension direction of the reinforcement.

### CROSS-REFERENCE TO RELATED APPLICATION

This application is based on and claims priority under 35 USC 119 from Japanese Patent Application No. 2014-129396 filed on Jun. 24, 2014, which is incorporated by reference herein.

### BACKGROUND

1. Technical Field

The present invention relates to a vehicle body structure.

2. Background Art

A vehicle body structure is known in which left and right front pillars are joined together by a framework member extending along the vehicle width direction (see, for example, Japanese Patent No. 2595760 (Patent Document 1)).

SUMMARY OF INVENTION

### Technical Problem

However, in a configuration in which a steering section (a steering wheel, a steering column, a steering shaft, and the like) is supported by the framework member, it is difficult to secure support rigidity of the steering section since the framework member is only supported by the front pillars. There is thus still room for improvement in structures to improve the support rigidity of a steering section.

Accordingly, an object of the present invention is to obtain a vehicle body structure enabling improved support rigidity of a steering section.

### Solution to Problem

A vehicle body structure according to a first aspect of the present invention includes a pair of left and right upper members that are disposed along a vehicle body longitudinal direction, a pair of left and right pillars that extend in a vehicle body vertical direction and that are disposed at vehicle width direction insides of the pair of left and right upper members, reinforcement that extends in a vehicle width direction, that is disposed between the pair of left and right pillars, and that supports a steering section, and a fastening portion where a vehicle width direction outside end portion of the reinforcement, the pillar, and the upper member are fastened together in the extension direction of the reinforcement.

According to the first aspect of the invention, the vehicle width direction outside end portion of the reinforcement that supports the steering section is fastened together with the pillar and the upper member in the extension direction of the reinforcement. Tensile force toward the vehicle width direction outsides is accordingly applied to the reinforcement, improving the rigidity and strength in the extension direction of the reinforcement. Support rigidity of the steering section is accordingly improved.

A vehicle body structure according to a second aspect is the vehicle body structure of the first aspect, wherein the reinforcement is formed in a circular cylinder shape.

According to the second aspect of the invention, the reinforcement is formed in a circular cylinder shape. The rigidity and strength in the extension direction of the reinforcement is accordingly more efficiently improved than in cases in which the reinforcement is not formed in a circular cylinder shape.

A vehicle body structure according to a third aspect is the vehicle body structure of the second aspect, wherein the fastening portion includes an adjustment member that is screwed counterclockwise into the vehicle width direction outside end portion of the reinforcement, and the adjustment member is configured so as to project out from the vehicle width direction outside end portion of the reinforcement and press the pillar toward the vehicle width direction outside by rotating clockwise during fastening of the vehicle width direction outside end portion of the reinforcement, the pillar, and the upper member together.

According to the third aspect of the invention, the adjustment member that is screwed counterclockwise into the vehicle width direction outside end portion of the reinforcement projects out from the vehicle width direction outside end portion of the reinforcement and presses the pillar toward the vehicle width direction outside by rotating clockwise during fastening of the vehicle width direction outside end portion of the reinforcement, the pillar, and the upper member together. Tensile force toward the vehicle width direction outsides is accordingly efficiently applied to the reinforcement, even more efficiently improving the rigidity and strength in the extension direction of the reinforcement.

A vehicle body structure according to a fourth aspect is the vehicle body structure of any one of the first aspect to the third aspect, wherein the pillar and the upper member are further fastened together at a location other than the fastening portion.

According to the fourth aspect of the invention, the pillar and the upper member are further fastened together at a location other than the fastening portion. The upper member is accordingly suppressed or prevented from undergoing pivoting deformation about the fastening portion when load is input to the upper member along the vehicle body longitudinal direction, such as in a frontal collision or a rear-end collision.

A vehicle body structure according to a fifth aspect is the vehicle body structure of any one of the first aspect to the fourth aspect, wherein in plan view, the upper members are disposed such that a separation between the upper members in the vehicle width direction increases on progression toward the vehicle body longitudinal direction inside.

According to the fifth aspect of the invention, the upper members are disposed such that, in plan view, the separation between the upper members in the vehicle width direction increases on progression toward the vehicle body longitudinal direction inside. Accordingly, in a frontal collision or a rear-end collision, for example, a portion of load input to the upper members along the vehicle body longitudinal direction is distributed as load toward the vehicle width direction outside (in the extension direction of the reinforcement) at the fastening portions, and this distributed load is efficiently absorbed by the reinforcement.

A vehicle body structure according to a sixth aspect is the vehicle body structure of any one of the first aspect to the fifth aspect, further including a side member that is disposed along the vehicle body longitudinal direction at a vehicle body lower side of the upper member as viewed along the vehicle width direction from the side, and a coupling member that couples a vehicle body longitudinal direction outside end portion of the upper member and a vehicle body longitudinal direction outside end portion of the side member together, wherein the coupling member includes a curved portion curving toward the vehicle body longitudinal direction outside.

According to the sixth aspect of the invention, the coupling member includes the curved portion curving toward the vehicle body longitudinal direction outside. When load is input to the coupling member along the vehicle body longitudinal direction, such as in a frontal collision or a rear-end collision, a cancelling moment acts against the input load due to the curved portion of the coupling member. Deformation of the coupling member is accordingly suppressed.

The first aspect of the invention enables improved support rigidity of a steering section.

The second aspect of the invention enables an efficient improvement to rigidity and strength in the extension direction of the reinforcement.

The third aspect of the invention enables an even more efficient improvement to rigidity and strength in the extension direction of the reinforcement.

The fourth aspect of the invention enables pivoting deformation of the upper member about the fastening portion due to load input along the vehicle body longitudinal direction to be suppressed or prevented.

The fifth aspect of the invention enables a portion of load input to the upper members along the vehicle body longitudinal direction to be efficiently absorbed by the reinforcement.

According to the sixth aspect of the invention, the curved portion enables a cancelling moment to act against load input to the coupling member along the vehicle body longitudinal direction, and enables deformation of the coupling member to be suppressed.

### BRIEF DESCRIPTION OF THE DRAWINGS

FIG. 1 is a perspective view illustrating a vehicle body structure according to a first exemplary embodiment;

FIG. 2 is a plan view cross-section illustrating a fastening portion of a vehicle body structure according to the first exemplary embodiment;

FIG. 3A and FIG. 3B are plan view cross-sections illustrating operation of an adjustment member in a fastening portion of a vehicle body structure according to the first exemplary embodiment;

FIG. 4 is a plan view illustrating a path of collision load transmission in a frontal collision involving the vehicle body structure according to the first exemplary embodiment; and

FIG. 5 is a plan view cross-section illustrating a fastening portion of a vehicle body structure according to a second exemplary embodiment.

### DESCRIPTION OF EMBODIMENTS

Detailed explanation follows regarding exemplary embodiments of the present invention, with reference to the drawings. For ease of explanation, in each of the drawings the arrow UP indicates the vehicle body upward direction, the arrow FR indicates the vehicle body front direction, and the arrow LH indicates the vehicle body left direction as appropriate. In the following explanation, unless specifically indicated, reference to front and rear, up and down, and left and right directions refers to the front and rear in the vehicle body longitudinal direction, up and down in the vehicle body vertical direction, and left and right in the vehicle body lateral direction (vehicle width direction). Moreover, although a vehicle body structure 10 according to the present exemplary embodiment may be applied to either a front section side or a rear section side of a vehicle 12, explanation follows regarding an example in which the vehicle body structure 10 is applied to the front section side of the vehicle 12.

### First Exemplary Embodiment

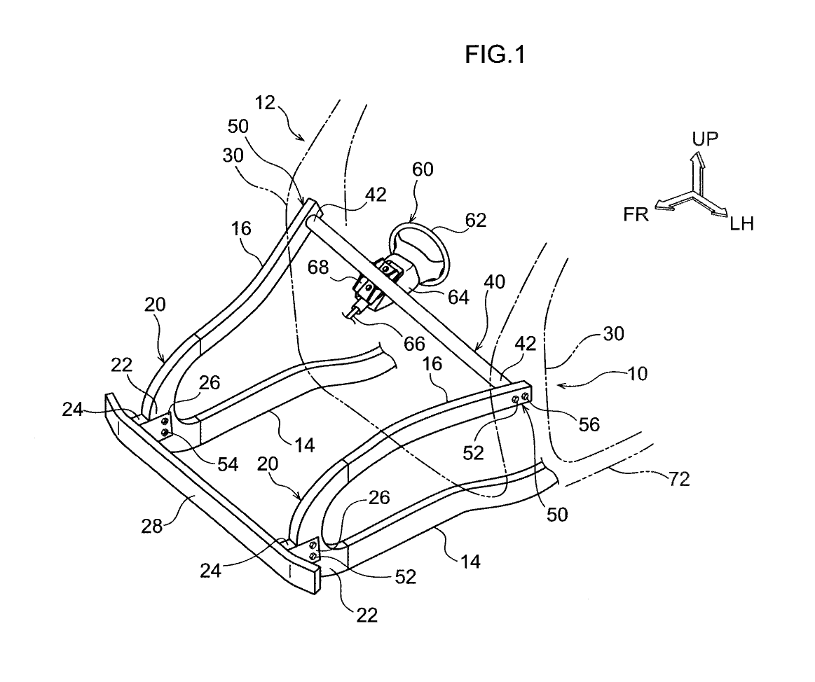

First, explanation follows regarding the vehicle body structure 10 according to a first exemplary embodiment. As illustrated in FIG. 1, a pair of left and right front side members 14 extending along the vehicle body longitudinal direction are disposed at the front section side of the vehicle 12. Each of the front side members 14 is formed with a rectangular shaped closed cross-section profile, by extrusion molding a lightweight metal material such as aluminum with a uniform cross-section.

Floor side members (not illustrated in the drawings) are integrally provided extending along the vehicle body longitudinal direction, contiguous to rear end portions of the respective front side members 14. Each of the floor side members is similarly formed with a rectangular shaped closed cross-section profile by extrusion molding a lightweight metal material such as aluminum with a uniform cross-section.

As viewed along the vehicle width direction from the side, a pair of left and right upper members 16 are disposed extending along the vehicle body longitudinal direction at the vehicle body upper side of the respective front side members 14. Each of the upper members 16 is formed with a rectangular shaped closed cross-section profile by extrusion molding a lightweight metal material such as aluminum with a uniform cross-section. The front side members 14 may also be understood as being disposed in a left and right pair extending along the vehicle body longitudinal direction at the vehicle body lower side of the respective upper members 16.

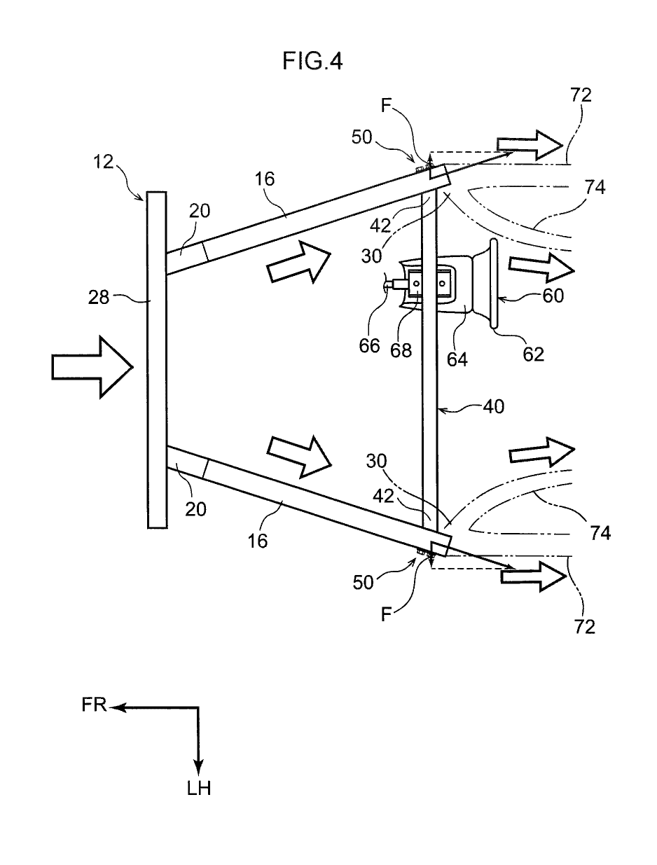

In plan view, the respective upper members 16 are disposed at the vehicle width direction outsides of the respective front side members 14, and are disposed such that the separation between them in the vehicle width direction increases on progression toward the vehicle body rear side (vehicle body longitudinal direction inside) (see FIG. 4). The cross-sectional area of each of the front side members 14 is formed so as to be greater than the cross-sectional area of the upper members 16. Namely, the respective front side members 14 are formed with a thicker rectangular shaped closed cross-section profile than the respective upper members 16.

Respective left and right front end portions (vehicle body longitudinal direction outside end portions) of the upper members 16 and left and right front end portions (vehicle body longitudinal direction outside end portions) of the front side members 14 are coupled together by coupling members (curved members) 20. Each of the coupling members 20 is formed from a lightweight metal material, such as aluminum and is substantially U-shaped as viewed from the side, and includes a curved portion 22 (curvature) so as to curve toward the vehicle body front side (the vehicle body longitudinal direction outside).

Note that as described above, the upper members 16 and the front side members 14 have different sized cross-sectional areas to each other, and the respective coupling members 20 couple together these members having different sized cross-sectional areas. The coupling members 20 are accordingly formed with rectangular shaped closed cross-section profiles by hydroforming a lightweight metal material with a uniform cross-section, or by joining together an outer panel and an inner panel.

An upper side rear end portion of each of the coupling members 20 is joined to the front end portion of the respective upper member 16 by arc welding or the like, and a lower side rear end portion of each of the coupling members 20 is joined to the front end portion of the respective front side member 14 by arc welding or the like. Note that the upper side rear end portions of the coupling members 20 may be overlapped with the front end portions of the upper members 16, and the lower side rear end portions of the coupling members 20 may be overlapped with the front end portions of the front side members 14, and fastened (joined) using bolts, rivets or the like. Moreover, the front side members 14, the upper members 16, and the coupling members 20 may be integrally formed together by hydroforming a lightweight metal material.

A crash box 24 is provided extending along the vehicle body longitudinal direction at a vehicle body lower side of a vehicle body vertical direction central portion of the curved portion 22 of each of the respective coupling members 20. The crash boxes 24 are each formed with a rectangular shaped closed cross-section profile from a lightweight metal material such as aluminum. A rear end portion of each crash box 24 is integrally formed with a fitting portion 26 capable of cladding the curved portion 22 of the respective coupling member 20.

Each fitting portion 26 is formed with two through holes (not illustrated in the drawings) penetrating in the vehicle width direction. Side walls of the respective curved portions 22 of the coupling members 20 that are covered by the respective fitting portions 26 are also formed with two through holes (not illustrated in the drawings) penetrating in the vehicle width direction, and these respective through holes are capable of being placed in communication with the respective through holes of the respective fitting portions 26.

The respective fitting portions 26 accordingly fit around the curved portions 22 of the respective coupling members 20, and bolts 52 are inserted through the through holes that are in communication with each other from the vehicle width direction outside (or inside), and screwed together with nuts 54, thereby fastening (joining) the crash boxes 24 at the vehicle body lower side of the vehicle body vertical direction central portion of each of the curved portions 22. Note that in order to suppress cross-sectional deformation due to fastening, circular cylinder shaped collar members (not illustrated in the drawings) may be provided in advance inside the curved portions 22, in communication with the respective through holes.

There is no limitation to configurations in which the respective crash boxes 24 are joined to the respective curved portions 22 by the bolts 52 and the nuts 54, and configuration may be made in which the crash boxes 24 are fastened (joined) to the respective curved portion 22 using rivets or the like, not illustrated in the drawings. Configuration may also be made in which the respective crash boxes 24 are joined to the respective curved portions 22 by arc welding or the like.

Front bumper reinforcement 28 extending along the vehicle width direction spans between front end portions of the respective crash boxes 24. The front bumper reinforcement 28 is formed with a rectangular shaped closed cross-section profile by extrusion molding a lightweight metal material such as aluminum with a uniform cross-section. A rear wall of the front bumper reinforcement 28 is joined to the front end portions of the respective crash boxes 24 by arc welding or the like. Configuration may also be made in which the front bumper reinforcement 28 is fastened (joined) to the front end portions of the respective crash boxes 24 using bolts, rivets, or the like.

There is no limitation to forming the respective front side members 14, the upper members 16, and the front bumper reinforcement 28 by extrusion molding a lightweight metal material with a uniform cross-section, and for example, the closed cross-section profiles thereof may be formed by joining together outer panels and inner panels, not illustrated in the drawings. The front side members 14, the upper members 16, and the front bumper reinforcement 28 may also be configured with rectangular shaped closed cross-section profiles that are integrally formed with one or plural dividing walls within the closed cross-section profile, in order to suppress cross-sectional deformation occurring due to the input of load.

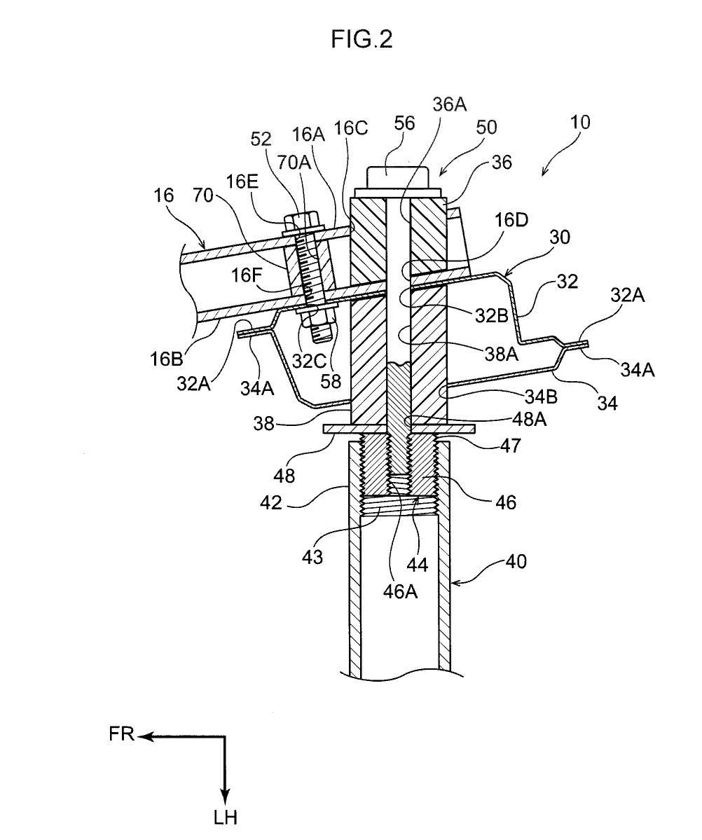

As illustrated in FIG. 1 and FIG. 2, rear end portions of the respective upper members 16 extend up to the vehicle width direction outsides of a pair of front pillars 30, respectively disposed on the left and right. The rear end portions of the respective upper members 16 are directly fixed by bolts through the respective front pillars 30 to vehicle width direction outside end portions (referred to below as “outside end portions”) 42 of instrument panel reinforcement 40 that extends along the vehicle width direction, in the extension direction (axial direction) of the instrument panel reinforcement 40 (these fixing locations are referred to below as “fastening portions 50”).

As illustrated in FIG. 1, a steering section 60 including, for example, a steering wheel 62, a steering column 64, and a steering shaft 66, is attached through a bracket 68 to a portion partway along the instrument panel reinforcement 40 in the vehicle width direction. Namely, the steering section 60 is supported by the instrument panel reinforcement 40.

As illustrated in FIG. 2, a through hole 16C, through which a circular cylinder shaped resin collar member 36 is inserted, is formed to an outside wall 16A at the rear end portion of each of the upper members 16. A through hole 16D, through which a flange bolt 56 is inserted, is formed to an inside wall 16B at the rear end portion of each of the upper members 16.

A vehicle width direction inside end portion of the collar member 36 is cut away diagonally so as to follow the inside wall 16B of the upper member 16. A through hole 36A, through which the flange bolt 56 is inserted, is formed to an axial center portion of the collar member 36. The through hole 16D is formed with a smaller diameter than the through hole 16C, such that the collar member 36 cannot pass through.

The front pillars 30 that are disposed at the vehicle width direction insides of the respective upper members 16 and extend in the vehicle body vertical direction each include an outer panel 32 with a substantially hat shaped cross-section profile, and an inner panel 34 with a substantially hat shaped cross-section profile. Flanges 32A of the outer panel 32, and flanges 34A of the inner panel 34, are respectively joined together such that the front pillar 30 is formed with a closed cross-section profile.

In plan view, the outer panel 32 and the inner panel 34 of each front pillar 30 are each disposed at an angle so as to follow the upper member 16. A lower end portion of each front pillar 30 is connected to a front end portion of a rocker 72 (see FIG. 1 and FIG. 4), and an upper end portion of each front pillar 30 is connected to a front end portion of a roof side rail 74 (see FIG. 4).

A through hole 32B, through which the flange bolt 56 is inserted, is formed to the outer panel 32, and a through hole 34B, through which a circular cylinder shaped resin collar member 38 is inserted, is formed to the inner panel 34. A vehicle width direction outside end portion of the collar member 38 is cut away diagonally so as to follow the outer panel 32, and a through hole 38A, through which the flange bolt 56 is inserted, is formed at an axial center portion of the collar member 38. The through hole 32B is formed with a smaller diameter than the through hole 34B, such that the collar member 38 cannot pass through.

In the present exemplary embodiment, the external diameter of the collar member 36 is set so as to be the same as the external diameter of the collar member 38; however there is no limitation thereto. Namely, the through hole 16C and the through hole 34B are each set with an internal diameter substantially the same as the external diameter of the respective collar members 36, 38, and the through hole 16D and the through hole 32B are each set with an internal diameter substantially the same as the external diameter of the flange bolt 56; however there is no limitation thereto.

The instrument panel reinforcement 40 extending along the vehicle width direction is what is referred to as a pipe, and is formed in a circular cylinder shape from a lightweight metal material such as aluminum with a uniform cross-section. A reverse thread 43 is provided at an inner peripheral face of each outside end portion 42 of the instrument panel reinforcement 40. The outside end 42 is further provided with an adjustment member 44 that screws into the instrument panel reinforcement 40 when rotated counterclockwise.

Specifically, the adjustment member 44 includes a circular cylinder shaped main body 46, and a circular plate shaped flange 48 that is integrally joined to an axial direction outside end portion of the main body 46. A through hole is formed at an axial center portion of the main body 46, and an inner peripheral face of the through hole is formed with a thread 46A that screws together with the flange bolt 56.

The external diameter of the flange 48 is formed larger than the external diameter of the main body 46, and a through hole that is in communication with the through hole of the main body 46, and through which the flange bolt 56 passes, is formed at an axial center portion of the flange 48. An outer peripheral face of the main body 46 is formed with a reverse thread 47 that screws together with the reverse thread 43.

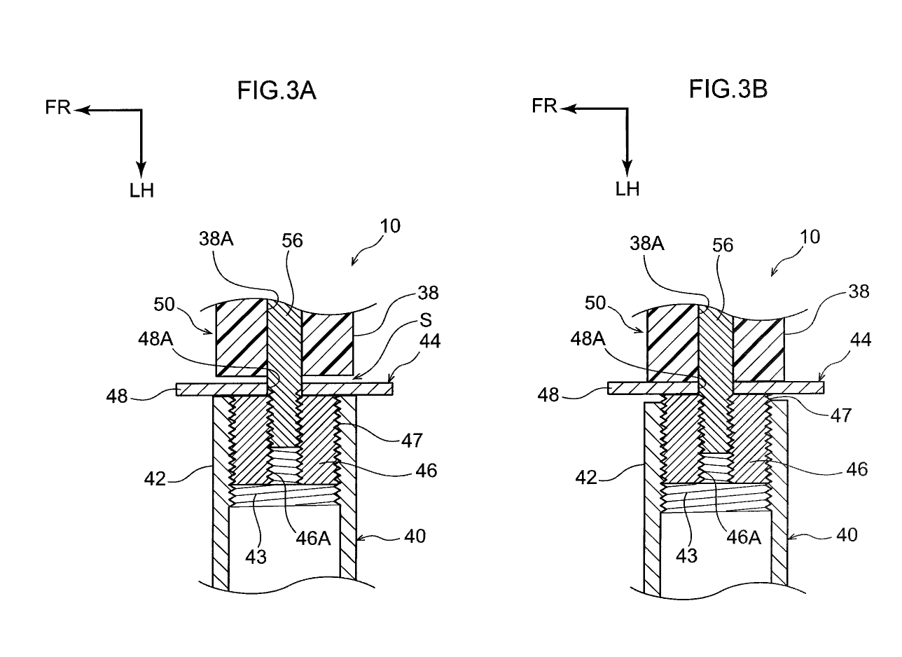

The upper member 16 and the front pillar 30 are fastened to the outside end portion 42 of the instrument panel reinforcement 40 by the flange bolt 56 and the adjustment member 44 in the following manner. First, as illustrated in FIG. 3A, the adjustment member 44 is rotated counterclockwise and screwed into the outside end portion 42 of the instrument panel reinforcement 40 in advance.

As illustrated in FIG. 2, the collar member 36 is inserted through the through hole 16C from the vehicle width direction outside, and the collar member 38 is inserted through the through hole 34B from the vehicle width direction inside. The through hole 36A of the collar member 36, the through hole 16D of the upper member 16, the through hole 32B of the front pillar 30, and the through hole 38A of the collar member 38 are accordingly placed in communication with each other.

The flange bolt 56 is then inserted through the respective through holes 36A, 16D, 32B, 38A, 48A from the vehicle width direction outside, and rotated clockwise to screw the flange bolt 56 together with the thread 46A of the adjustment member 44. This screwing together is performed with the adjustment member 44 restrained, preventing the adjustment member 44 from rotating clockwise.

This state is a temporary fixing state, illustrated in FIG. 3A. When in this state, a space S is formed between the flange 48 and the collar member 38. The flange bolt 56 is then screwed together with the adjustment member 44 without restraining the adjustment member 44, such that the adjustment member 44 rotates clockwise together with the flange bolt 56 and projects out from the outside end portion 42 of the instrument panel reinforcement 40, and the flange 48 abuts (contacts) the collar member 38, as illustrated in FIG. 3B.

In this state, the flange bolt 56 is screwed further into the thread 46A until a specific torque is reached, such that the collar member 38 prevents the adjustment member 44 from moving toward the vehicle width direction outside, and the flange 48 tightly contacts the collar member 38 (the adjustment member 44 presses the front pillar 30 relatively toward the vehicle width direction outside) accompanying screwing of the flange bolt 56 together with the thread 46A.

This state is a fully fixed state, illustrated in FIG. 2 and FIG. 3B. Tensile force (a reaction force to compression force) toward the vehicle width direction outside is applied to the instrument panel reinforcement 40, and the upper member 16 and the front pillar 30 are fastened to the outside end portion 42 of the instrument panel reinforcement 40 in the axial direction (extension direction) of the instrument panel reinforcement 40 in this state. The flange bolt 56 is fastened in a state in which the axial center of the flange bolt 56 is aligned with the axial center of the instrument panel reinforcement 40.

As illustrated in FIG. 2, the upper member 16 and the front pillar 30 are also fastened together by a bolt further to the vehicle body front side than the fastening portion 50, so as to suppress or prevent the upper member 16 from undergoing pivoting deformation in the vehicle body vertical direction about the fastening portion 50 (the flange bolt 56) in the event that the vehicle 12 is involved in a frontal collision (when load is input to the upper member 16 from the vehicle body front side).

More specifically, the outer panel 32 is formed with a through hole 32C, and a weld nut 58 is provided coaxially to the through hole 32C at an inner face side of the outer panel 32. The outside wall 16A and the inside wall 16B of the upper member 16 are formed with a through hole 16E and a through hole 16F respectively, and a collar member 70 is disposed inside the upper member 16 such that a through hole 70A is in communication with the respective through holes 16E, 16F.

A bolt 52 is inserted through the respective through holes 16E, 70A, 16F, 32C from the vehicle width direction outside and screwed together with the weld nut 58, thereby fastening and fixing the upper member 16 to the front pillar 30. Pivoting deformation of the upper member 16 about the fastening portion 50 is accordingly suppressed or prevented.

Explanation follows regarding operation of the vehicle body structure 10 according to the first exemplary embodiment, configured as described above.

Each upper member 16 is fastened directly to the respective outside end portion 42 of the instrument panel reinforcement 40 through the respective front pillars 30, along the axial direction (extension direction) of the instrument panel reinforcement 40. The adjustment members 44 are provided at the fastening portions 50, such that the instrument panel reinforcement 40 is applied with tensile force toward the axial direction (vehicle width direction) outsides.

The support rigidity (support strength) of the instrument panel reinforcement 40 that supports the steering section 60 can accordingly be increased. This thereby enables an improvement in the steering stability performance of the vehicle 12, and enables a reduction in vibrations transmitted to the steering wheel 62. Gaps due to molding tolerances, arising during assembly of the upper members 16, the front pillars 30, and the instrument panel reinforcement 40, can accordingly be absorbed using the adjustment member 44.

As illustrated in FIG. 4, when the vehicle 12 is involved in a frontal collision (a full overlap collision or an offset collision), collision load input to the front bumper reinforcement 28 crushes the crash boxes 24 (omitted from illustration in FIG. 4) along their axial direction (along the vehicle body longitudinal direction), absorbing a portion of the collision load. Collision load that is not completely absorbed by the crash boxes 24 is transmitted through the fitting portions 26 to the curved portions 22 of the coupling members 20.

The coupling members 20, including the curved portions 22 that are curved toward the vehicle body front side, are coupled to the front end portions of the upper members 16 and the front end portions of the front side members 14 that are separated in the vehicle body vertical direction as viewed from the side. A cancelling moment against the collision load input from the vehicle body front side (the crash boxes 24) acts on the curving curved portions 22.

The curved portions 22 accordingly do not readily deform (have high rigidity), even when collision load is input to the curved portions 22 from the vehicle body front side, thereby suppressing or preventing buckling (folding deformation) of the coupling members 20. The collision load input to the curved portions 22 of the coupling members 20 is accordingly transmitted to the front side members 14, and also transmitted (distributed) to the upper members 16.

The collision load transmitted to the front side members 14 is further transmitted from the front side members 14 to the floor side members. The collision load transmitted to the upper members 16 is further transmitted from the upper members 16 to the front pillars 30, the rockers 72, and the roof side rails 74.

Note that in plan view, the left and right upper members 16 are disposed at an angle such that the separation between them in the vehicle width direction increases on progression toward the vehicle body rear side. This thereby enables a distributed load F toward the vehicle width direction outsides to be efficiently generated in the fastening portions 50 of the instrument panel reinforcement 40 from the collision load input to the upper members 16.

This thereby enables a portion of the collision load input to the upper members 16 to be absorbed as axial force (tensile force) in the instrument panel reinforcement 40, enabling the load transmitted to the front pillars 30, the rockers 72 and the roof side rails 74 to be reduced. The vehicle body structure 10 according to the present exemplary embodiment thereby enables an increase in the rigidity and strength of the vehicle 12, accordingly enabling improved collision safety performance of the vehicle 12.

When the vehicle 12 is involved in an offset collision, and collision load is input to a single upper member 16, the distributed load F toward the vehicle width direction outside is generated at only one of the fastening portions 50 of the instrument panel reinforcement 40. However, a portion of the collision load can also be absorbed by the upper member 16, the front pillar 30, and so on at the side opposite to the collision side, through the instrument panel reinforcement 40.

When the vehicle 12 is involved in a side-on collision, collision load can be transmitted through the instrument panel reinforcement 40 to the upper member 16, the front pillar 30, and so on at the opposite side to the collision side of the instrument panel, without crushing the reinforcement 40. The vehicle body structure 10 according to the present exemplary embodiment accordingly enables collision load input to one of the upper members 16 and the front pillars 30 to be distributed to the other of the upper members 16 and the front pillars 30, thereby enabling a reduction in damage (deformation) of the vehicle 12.

Collision load transmitted to the front side members 14 can be transmitted to the floor side members, and collision load transmitted to the upper members 16 can be transmitted to the front pillars 30, the rockers 72, and the roof side rails 74, thereby enabling a reduction in load concentration in the front side members 14 and the upper members 16. This thereby enables the front side members 14 and the upper members 16 to be adequately configured from a lightweight metal material such as aluminum that has lower strength than sheet steel.

The front side members 14 and the upper members 16 do not need to be strengthened by increasing the plate thickness, or by using reinforcement or the like (by increasing the number of components) (a simple structure is achieved), thereby enabling a reduction in weight of the vehicle 12. Moreover, the number of manufacturing processes of the front side members 14 and the upper members 16 can be reduced, enabling a saving in expenditure on equipment, and enabling improved productivity for the front side members 14 and the upper members 16.

Next, explanation follows regarding a vehicle body structure 10 according to a second exemplary embodiment. Note that locations corresponding to those in the first exemplary embodiment described above are allocated the same reference numerals, and detailed explanation (including that of common operation) is omitted as appropriate.

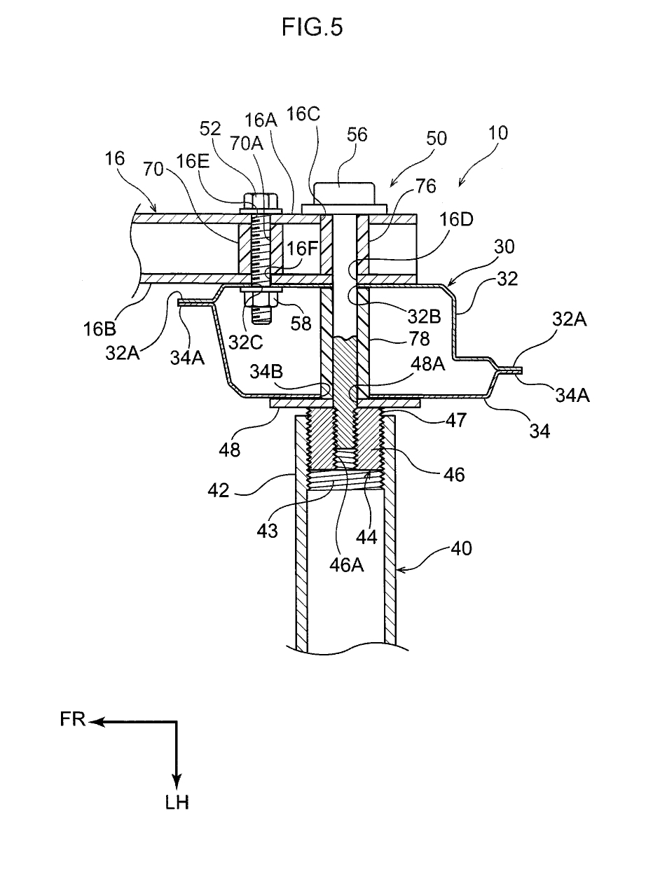

As illustrated in FIG. 5, in the second exemplary embodiment, in plan view the rear end portions of the upper member 16 are formed extending along the vehicle body longitudinal direction so as to be orthogonal to the axial direction (extension direction) of the instrument panel reinforcement 40. The outer panel 32 and the inner panel 34 of the front pillar 30 are likewise disposed orthogonally to the axial direction (extension direction) of the front pillar 30, following the upper member 16.

In the vehicle body structure 10 according to the second exemplary embodiment configured in this manner, a vehicle width direction inside end portion of a collar member 76 provided to the upper member 16, and a vehicle width direction outside end portion of a collar member 78 provided to the front pillar 30 do not need to be cut away diagonally. This is advantageous since it enables the shapes of the collar members 76, 78 to be configured more simply than the shapes of the collar members 36, 38 (a simple component structure is sufficient).

Explanation regarding the vehicle body structure 10 of the present exemplary embodiments has been given with reference to the drawings. However, the vehicle body structure 10 according to the present exemplary embodiments is not limited to that illustrated, and design may be modified as appropriate within a range not departing from the spirit of the present invention. For example, the coupling members 20 are preferably configured including the curved portions 22 that curve toward the vehicle body front side; however configuration may be made without the curved portions 22 as long as the configuration is provided with rigidity comparable to that of the curved portions 22.

It is sufficient that at least the outside end portions 42 of the instrument panel reinforcement 40 are circular cylinder shaped, and the shape of intermediate portions other than the outside end portions 42 is not limited to a circular cylinder shape. Configuration may be made with the adjustment members 44 omitted, as long as tensile force toward the vehicle width direction outsides is applied to the instrument panel reinforcement 40 when the upper members 16 and the front pillars 30 are fastened to the instrument panel reinforcement 40.

The upper member 16 and the front pillar 30 do not have to be fastened and fixed at another location as well as the fastening portion 50, as long as the configuration does not permit pivoting deformation of the upper members 16 in the vehicle body vertical direction about the fastening portions 50 when the vehicle 12 is involved in a frontal collision. Moreover, the upper members 16 do not have to be disposed such that the separation between them in the vehicle width direction increases on progression toward the vehicle body rear side in plan view, as long as a portion of collision load input to the upper members 16 is absorbed as axial force (tensile force) in the instrument panel reinforcement 40.

The collar members 36, 38 and the collar members 76, 78 do not have to be provided as long as the configuration secures adequate cross-sectional strength of the upper members 16 and the front pillars 30. However, if the collar members 38 are not provided in the vehicle body structure 10 of the first exemplary embodiment, the inner panels 34 of the front pillars 30 are preferably formed with flat face portions (not illustrated in the drawings) orthogonal to the axial direction (extension direction) of the instrument panel reinforcement 40, and the flanges 48 of the adjustment members 44 placed in tight contact with the flat face portions.

1. A vehicle body structure comprising:
a pair of left and right upper members that are disposed along a vehicle body longitudinal direction;
a pair of left and right pillars that extend in a vehicle body vertical direction and that are disposed at vehicle width direction insides of the pair of left and right upper members;
reinforcement that extends in a vehicle width direction, that is disposed between the pair of left and right pillars, and that supports a steering section; and
a fastening portion where a vehicle width direction outside end portion of the reinforcement, the pillar, and the upper member are fastened together in the extension direction of the reinforcement.

2. The vehicle body structure of claim 1, wherein the reinforcement is formed in a circular cylinder shape.

3. The vehicle body structure of claim 2, wherein:
the fastening portion includes an adjustment member that is screwed counterclockwise into the vehicle width direction outside end portion of the reinforcement; and
the adjustment member is configured so as to project out from the vehicle width direction outside end portion of the reinforcement and press the pillar toward the vehicle width direction outside by rotating clockwise during fastening of the vehicle width direction outside end portion of the reinforcement, the pillar, and the upper member together.

4. The vehicle body structure of claim 1, wherein the pillar and the upper member are further fastened together at a location other than the fastening portion.

5. The vehicle body structure of claim 1, wherein in plan view, the upper members are disposed such that a separation between the upper members in the vehicle width direction increases on progression toward the vehicle body longitudinal direction inside.

6. The vehicle body structure of claim 1, further comprising:
a side member that is disposed along the vehicle body longitudinal direction at a vehicle body lower side of the upper member as viewed along the vehicle width direction from the side; and
a coupling member that couples a vehicle body longitudinal direction outside end portion of the upper member and a vehicle body longitudinal direction outside end portion of the side member together, wherein
the coupling member includes a curved portion curving toward the vehicle body longitudinal direction outside.
